(19) United States
(12) Patent Application Publication
(10) Pub. No.: US 2019/0348876 A1
(43) Pub. Date: Nov. 14, 2019

(54) CONSEQUENT-POLE MOTOR ROTOR WITH MAGNETIC-FLUX-SEPARATING RECESSES

(71) Applicant: NEW WIDETECH INDUSTRIES CO., LTD., New Taipei City (TW)

(72) Inventors: MING-TSUNG CHIU, NEW TAIPEI CITY (TW); CHUNG-MING LIN, NEW TAIPEI CITY (TW); YAO YANG HSIEH, NEW TAIPEI CITY (TW); JUI AN CHIANG, NEW TAIPEI CITY (TW)

(21) Appl. No.: 15/973,706

(22) Filed: May 8, 2018

(51) Int. Cl. H02K 1/27

(52) U.S. Cl. CPC H02K 1/274

(57) ABSTRACT

A consequent-pole motor rotor with magnetic-flux-separating recesses has a main body and multiple magnets. The main body has multiple magnet holes, multiple rotor air hole assemblies, and multiple magnetic-flux-separating recess assemblies. The magnet holes and the rotor air hole assemblies are formed through the main body. The magnetic-flux-separating recess assemblies are radially formed in a radial outer surface of the main body and extend through two axial end surfaces of the same. Each magnetic-flux-separating recess assembly has at least one magnetic-flux-separating recess. The magnetic lines produced during the operating of the motor can be pushed by the magnetic-flux-separating recesses toward the center of the main body, so the outermost magnetic line will be less likely to deviate from its path and probability of cogging torque in the motor during operation is reduced.

### BACKGROUND OF THE INVENTION

### 1. Field of the Invention

The present invention relates to an improvement on a structure of a motor, especially to an improvement for a rotor of a consequent-pole motor.

### 2. Description of the Prior Arts

With reference to FIG. 9, a consequent-pole motor is a kind of motor used inside a compressor. A conventional consequent-pole motor comprises a stator 91 and a rotor 92. The rotor 92 is rotatably mounted inside the stator 91. Multiple coils 93 are mounted on the stator 91. The coils 93 can interact with multiple magnets 94, which are mounted on the rotor 92, so the coils 93, the stator 91 and the rotor 92 can jointly produce multiple closed magnetic circuits, in the following descriptions, the magnetic circuits are shown in the specification and the figures as magnetic line groups 95. Each magnetic line group 95 has multiple magnetic lines 96. The magnetic lines 96 are concentric and can pass through the rotor 92 and the stator 91 along specific magnetic circuits. The movement of the magnetic lines 96 along the magnetic circuits can produce changes in the magnetic field and force the rotor 92 to rotate relative to the stator 91, and therefore the consequent-pole motor can produce and transfer the required kinetic energy.

However, when the conventional consequent-pole rotor 92 is rotating, the lack of a reverse magnetic pole, which would be a guide for the magnetic circuits of the magnetic lines 96 on the magnets 94 of the rotor 92, will lead to a looser formation and structure for the magnetic line groups 95 and within the magnetic lines 96. Specifically, a radial outer surface of the rotor 92 is a smooth annular surface, and therefore after the formation of the magnetic line groups 95 and the magnetic lines 96, there is no restraint force formed along a periphery of the rotor 92 to push the magnetic line groups 95 closely together. As a result, within each magnetic line group 95, the outermost magnetic line 96 is prone to deviate from said magnetic line group 95 and then dissipate. Moreover, within each magnetic line group 95, the outermost magnetic line 96 is the farthest line to a coil on the stator 91, so when the rotor 92 is approaching the coils 93, the outermost magnetic line 96 will receive the least magnetic force to keep it from deviating from the magnetic line group 95. In other words, it is more difficult to keep the outermost magnetic line 96 within the correct magnetic circuit while the rotor 92 is rotating.

Once the outermost magnetic line has deviated, or with the occurrence of a phenomenon called “Magnetic Leakage”, it will cause a cogging torque in the rotor 92 and ends up as the vibration and noise in a motor, which will therefore influence the efficiency and the stability of the motor.

Therefore, the conventional consequent-pole motor rotor has defects in its design.

To overcome the shortcomings, the present invention provides a consequent-pole motor rotor with magnetic-flux-separating recesses to mitigate or obviate the aforementioned problems.

### SUMMARY OF THE INVENTION

The main objective of the present invention is to provide a consequent-pole motor rotor with magnetic-flux-separating recesses that are formed in a surface of the rotor, so the magnetic lines, which are produced by the magnets in the rotor, will be arranged more densely when passing through the surface of the rotor from an inside of the rotor. Therefore when the magnetic lines move toward the coils on the stator, the outermost magnetic line will not deviate easily.

The consequent-pole motor rotor with magnetic-flux-separating recesses has a main body and multiple magnets. The main body is a cylinder and has two axial end surfaces, a radial outer surface, multiple magnet holes, multiple rotor air hole assemblies, and multiple magnetic-flux-separating recess assemblies. The magnet holes are axially formed through the main body. The rotor air hole assemblies are axially formed through the main body, corresponding in number and position to the magnet holes respectively, and each one of the rotor air hole assemblies has two rotor air holes respectively disposed in two opposite sides of a corresponding one of the magnet holes. The magnetic-flux-separating recess assemblies are radially formed in the radial outer surface of the main body, annularly arranged apart from each other, and axially extending to the two axial end surfaces of the main body. And each of the multiple magnetic-flux-separating recess assemblies has at least one magnetic-flux-separating recess. The magnets are respectively mounted in the magnet holes of the main body.

Given the forgoing structure of the consequent-pole motor rotor with magnetic-flux-separating recesses, the multiple magnetic-flux-separating recess assemblies which are formed in the radial outer surface of the rotor can produce higher reluctance forces when the magnetic lines are passing through the radial outer surface of the rotor along a magnetic circuit. The reluctance forces can force the magnetic lines on a periphery of the magnetic circuit to move closer to the center of the magnetic line group to which said magnetic lines belongs. Therefore, the magnetic lines may be centralized and be more stable and therefore lower the probability of magnetic leakage and enhance the stability and efficiency of the motor.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a consequent-pole motor rotor with magnetic-flux-separating recesses in accordance with the present invention;

FIG. 2 is a front view of the consequent-pole motor rotor in FIG. 1;

FIG. 3 is an enlarged view of the magnetic lines in the stator in the first embodiment while operating;

FIG. 4 is an enlarged view of the magnetic lines in the stator in the second embodiment while operating;

FIG. 5 is an enlarged view of the magnetic lines in the stator in the third embodiment while operating;

FIG. 6 is an enlarged view of the magnetic lines in the stator in the fourth embodiment while operating;

FIG. 7 is a perspective view of a fifth embodiment of a consequent-pole motor rotor with magnetic-flux-separating recesses in accordance with the present invention;

FIG. 8 is an enlarged view of the magnetic lines in the stator in the fifth embodiment while operating; and

FIG. 9 is an enlarged view of the magnetic lines in the stator in the conventional motor while operating.

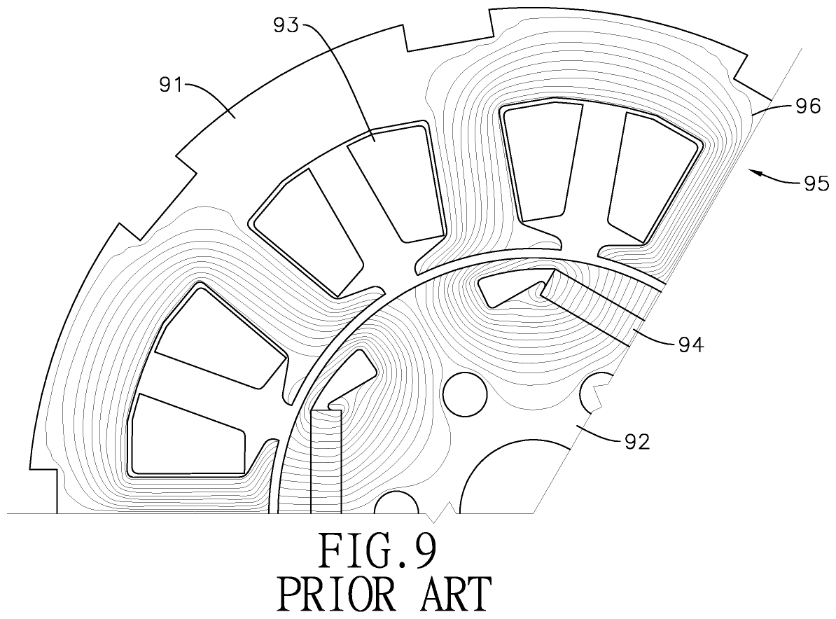

### DETAILED DESCRIPTION OF THE PREFERRED EMBODIMENTS

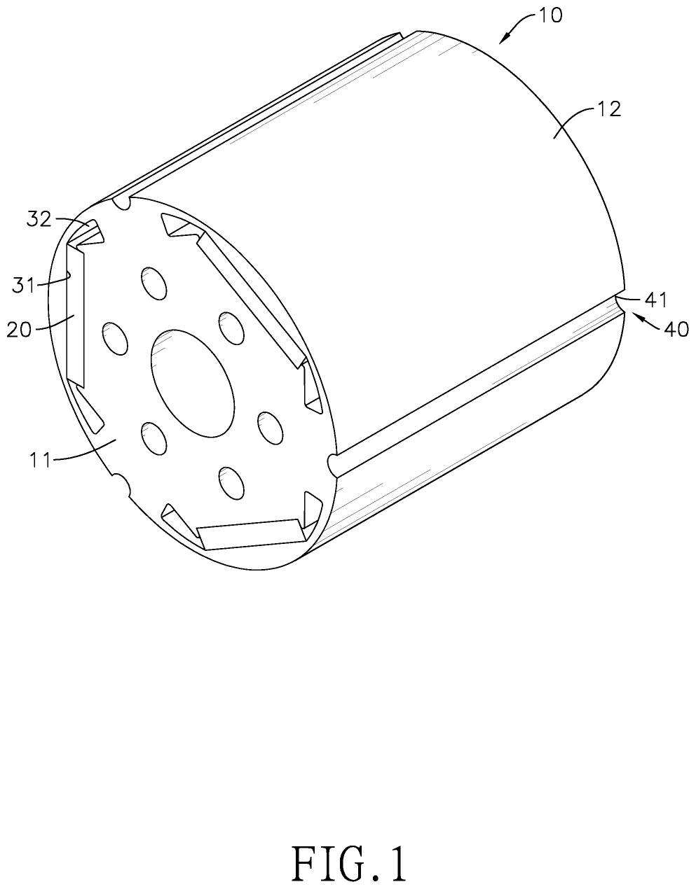

With reference to FIG. 1, a consequent-pole motor rotor with magnetic-flux-separating recesses in accordance with the present invention comprises a main body 10 and multiple magnets 20. The magnets 20 are mounted inside the main body 10.

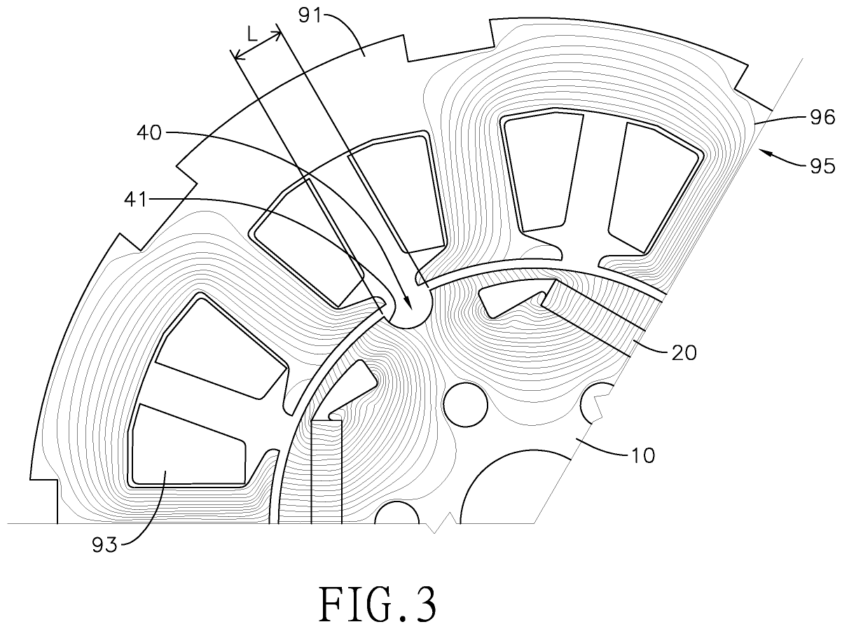

With reference to FIGS. 1 and 3, the main body 10 is a cylinder and has two axial end surfaces 11 and a radial outer surface 12. The radial outer surface 12 is an annular surface, and the two axial end surfaces 11 are respectively connected to two opposite ends of the radial outer surface 12. The main body 10 further comprises multiple magnet holes 31, multiple rotor air hole assemblies 32, and multiple magnetic-flux-separating recess assemblies 40. The magnet holes 31 are axially formed through the main body 10. In other words, the magnet holes 31 are respectively and axially formed from one axial end surface 11 to the other axial end surface 11. In the first embodiment, the magnet holes 31 are annularly arranged apart from each other around an axle center of the main body 10.

The rotor air hole assemblies 32 are axially formed through the main body 10. Moreover, the rotor air hole assemblies 32 correspond in number and position to the magnet holes 31 respectively. Specifically, each rotor air hole assembly 32 has two rotor air holes 321, and the two rotor air holes 321 are respectively disposed in two opposite sides of the corresponding magnet hole 31. In the first embodiment, the two rotor air holes 321 communicate with the corresponding magnet hole 31 and are disposed in two opposite sides of said magnet hole 31 along a periphery of the main body 10.

The magnets 20 are respectively mounted in the magnet holes 31 so as to be mounted inside the main body 10. Furthermore, a magnetic direction of each magnet 20 should unanimously point to an outer side of the rotor or an inner side of the main body 10.

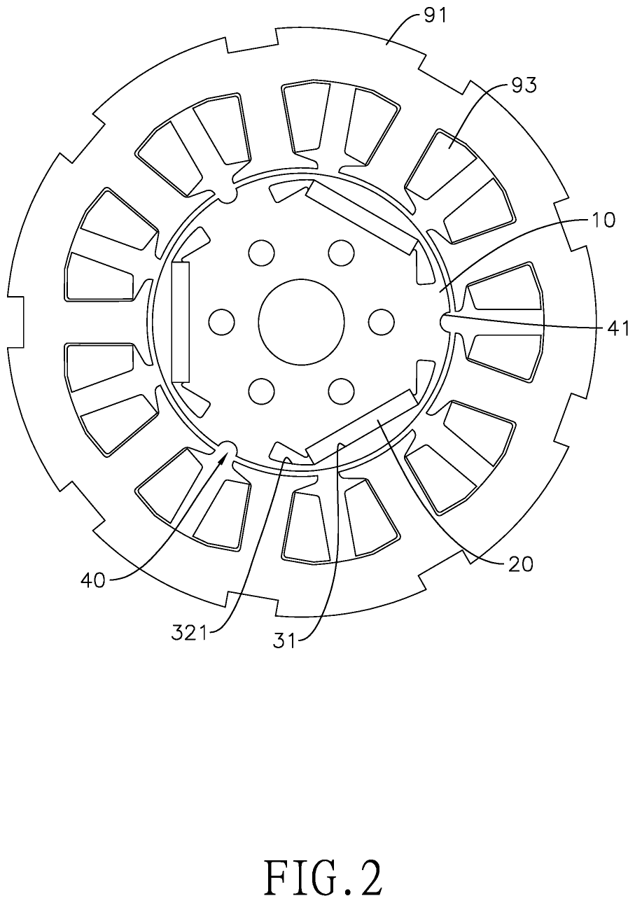

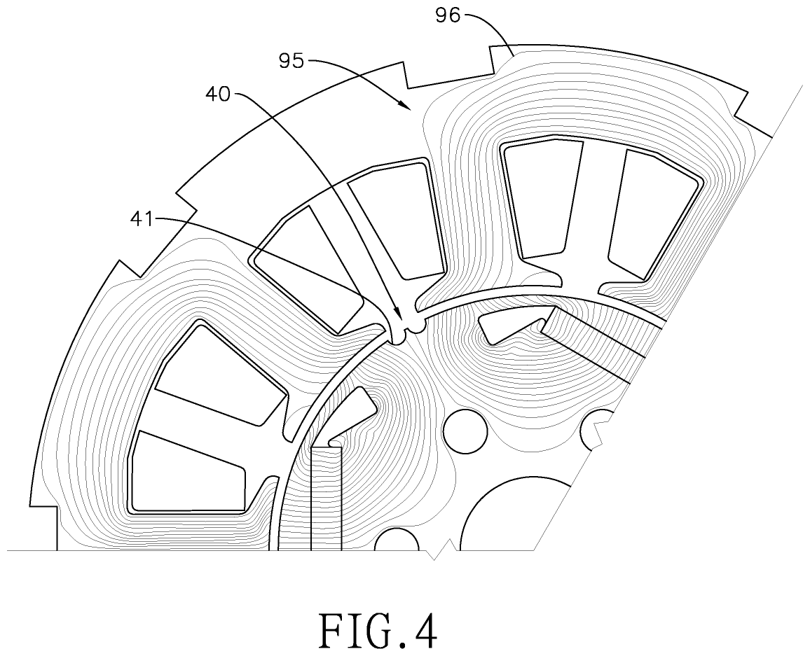

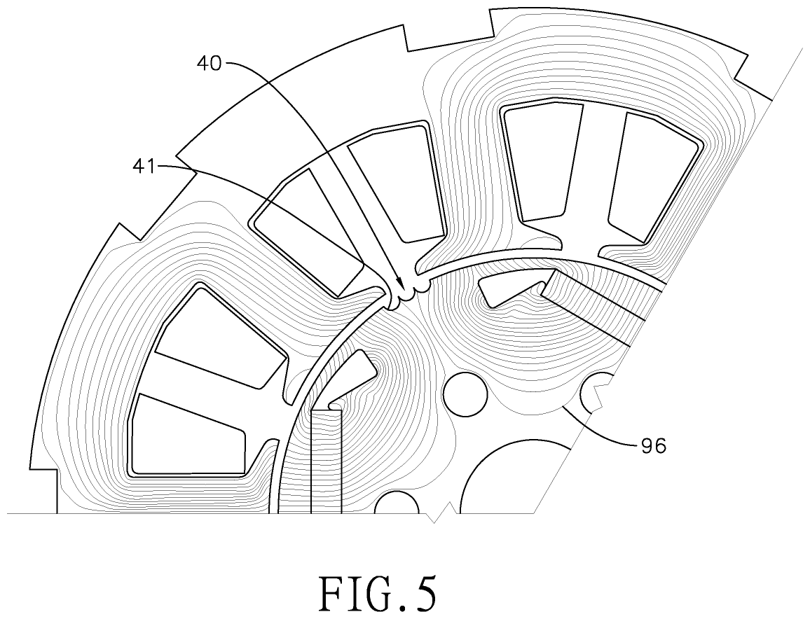

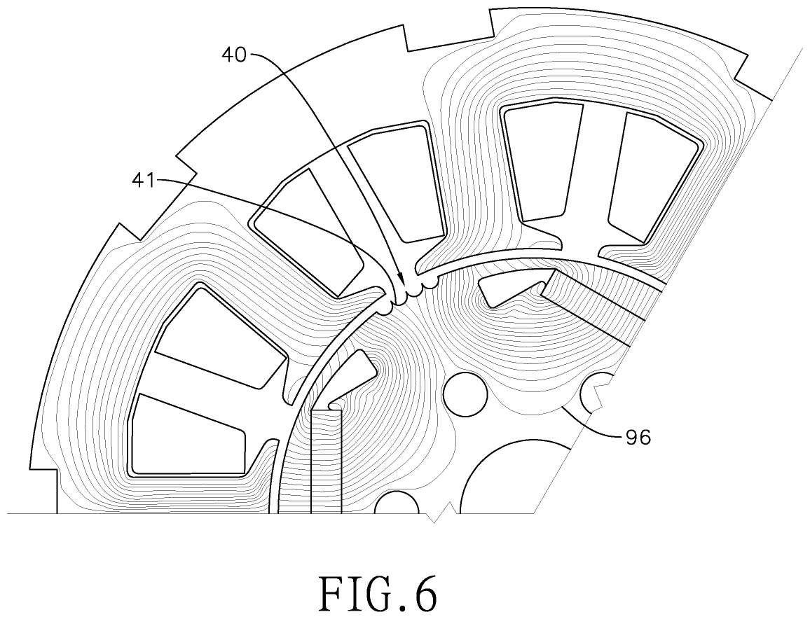

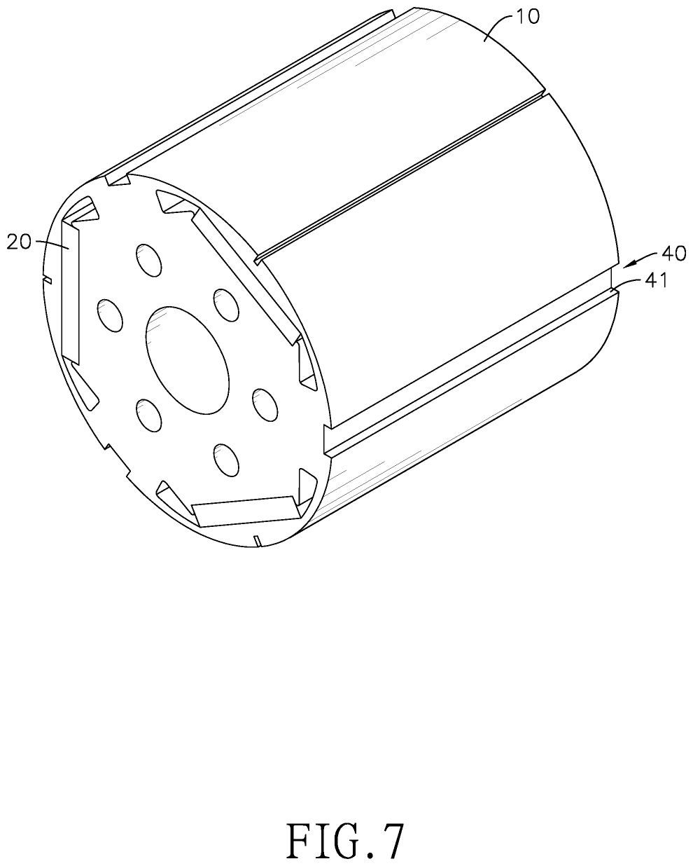

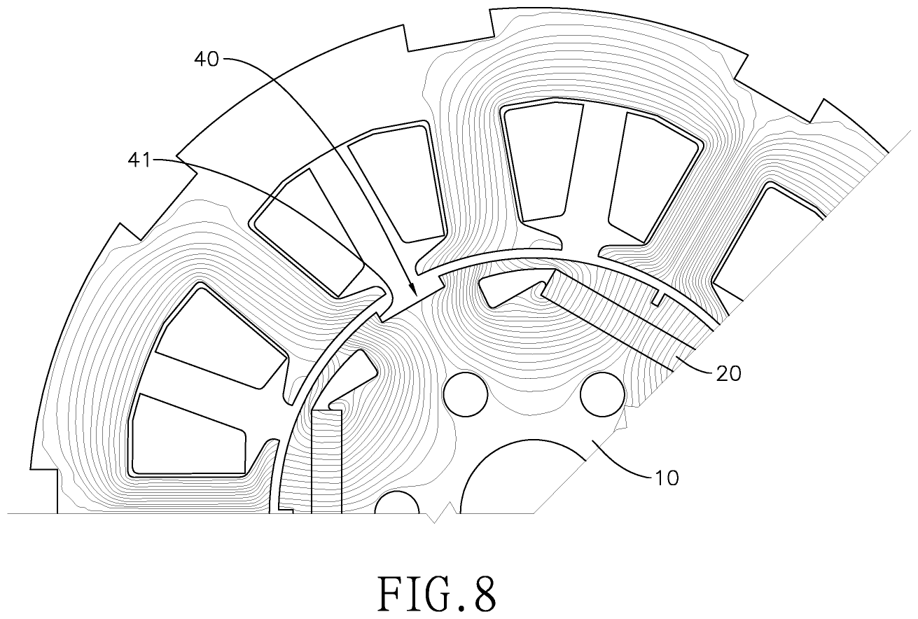

The magnetic-flux-separating recess assemblies 40 are respectively and radially formed in the radial outer surface 12 of the main body 10. The magnetic-flux-separating recess assemblies 40 are annularly arranged apart from each other around the axle center of the main body 10. The magnetic-flux-separating recess assemblies 40 respectively extend to the two axial end surfaces 11 of the main body 10. Each magnetic-flux-separating recess assembly 40 has at least one magnetic-flux-separating recess 41. The position of each magnetic-flux-separating recess assembly 40, the number of the magnetic-flux-separating recess 41 in each magnetic-flux-separating recess assembly 40, and the shape of each magnetic-flux-separating recess 41 are all adjustable. The following five embodiments are presented to elaborate some of the configurations of the magnetic-flux-separating recess assembly 40. The first embodiment is presented in FIGS. 1 to 3. The second to the fourth embodiments are respectively presented in FIGS. 4 to 6. The fifth embodiment is presented in FIGS. 7 and 8. Regarding the position of the magnetic-flux-separating recess assembly 40, within the first to the fourth embodiments, the magnetic-flux-separating recess assemblies 40 are respectively disposed between every two adjacent said magnets 20 along the periphery of the main body 10. Specifically, each magnetic-flux-separating recess assembly 40 is disposed in a center between two corresponding adjacent magnets 20.

In the fifth and the sixth embodiments, a part of the magnetic-flux-separating recess assemblies 40 are formed respectively between every two adjacent said magnets 20, and the remaining magnetic flux separating assemblies 40 are respectively disposed in radial outer sides of the magnets 20 (which is also the radial outer surface 12). However, the positions of the magnetic-flux-separating recess assemblies 40 are not limited thereto. Regarding the shape of each magnetic-flux-separating recess 41 of each magnetic-flux-separating recess assembly 40: within the first to the fourth embodiments, each magnetic-flux-separating recess 41 is a round recess, specifically, but not limited to, a circular recess. The shape of each magnetic-flux-separating recess 41 may be altered to an arc shape from the circular shape to reduce a depth of the magnetic-flux-separating recess 41. In the fifth embodiment, each magnetic-flux-separating recess 41 is a rectangular recess. A depth of each rectangular recess is adjustable, and the rectangular recesses need not be of an equal width. In the fifth embodiment, for example, a width of a magnetic-flux-separating recess 41 of a magnetic-flux-separating recess assembly 40 that is disposed between two adjacent magnets 20 is larger than a width of a magnetic-flux-separating recess 41 of a magnetic-flux-separating recess assembly 40 that is disposed on a radial outer side of a magnet 20. However, it is not limit thereto, as the widths of the magnetic-flux-separating recesses 41 in the fifth embodiment may be the same. Regarding the number of the magnetic-flux-separating recess 41 in each magnetic-flux-separating recess assembly 40, in the first and the fifth embodiments, each magnetic-flux-separating recess assembly 40 has one magnetic-flux-separating recess 41. In the second to the fourth embodiments, each magnetic-flux-separating recess assembly 40 has multiple magnetic-flux-separating recesses 41. Specifically, the second, third, and fourth embodiments have respectively two, three, and four magnetic-flux-separating recesses 41 in each magnetic-flux-separating recess assembly 40.

Besides, in a preferred embodiment, an overall concavity width L of each magnetic-flux-separating recess assembly 40 on the main body 10 ranges from 0.5 mm to 6 mm, endpoints included, as shown in FIG. 3. Specifically, in the first and the fifth embodiments, which both have single magnetic-flux-separating recess 41 for each magnetic-flux-separating recess assembly 40, the overall concavity width of a magnetic-flux-separating recess assembly 40 is equal to an overall concavity width of the magnetic-flux-separating recess 41 of said magnetic-flux-separating recess assembly 40. Therefore, in the first and fifth embodiments, each magnetic-flux-separating recess 41 has a width ranging from 0.5 mm to 6 mm. In the second to the fourth embodiments, because a magnetic-flux-separating recess assembly 40 comprises multiple magnetic-flux-separating recesses 41, the overall concavity width of each magnetic-flux-separating recess assembly 40 equals to the total concavity width of each magnetic-flux-separating recesses 41. And the overall concavity width of each magnetic-flux-separating recess assembly 40 in the second to the fourth embodiments also ranges from 0.5 mm to 6 mm.

To sum up, the position of the magnetic-flux-separating recess assemblies 40, the number of the magnetic-flux-separating recesses 41 in each magnetic-flux-separating recess assembly 40, the shape of the magnetic-flux-separating recesses 41, and the overall concavity width of each magnetic-flux-separating recess assembly 40 are all adjustable and are not limited thereto. For example, when the magnetic-flux-separating recesses 41 are rectangular recesses, each magnetic-flux-separating recess assembly 40 may also comprise multiple magnetic-flux-separating recesses 41 to adjust the overall concavity width of said magnetic-flux-separating recess assembly 40. The operation process and the advantages of the present invention are elaborated as follows.

With reference to FIGS. 1, 3, and 4, a stator 91 is used with the present invention. The main body 10 of the present invention is rotatably mounted in the stator 91. When coils 93 on the stator 91 are electrified, the coils 93 and the magnets 20 on the main body 10 will jointly produce multiple magnetic line groups 95. Then the main body 10 can rotate constantly due to the magnetic interaction between the magnetic line groups 95 and the stator 91.

Wherein, the rotor air hole assemblies 32 can guide the magnetic line groups 95 to form an ideal magnetic circuit, so the magnetic line groups 95 and the magnetic circuit produced within the main body 10 and the stator 91 may be more stable.

Therefore, the advantages of the present invention are that: with the magnetic-flux-separating recesses 41 of the magnetic-flux-separating recess assemblies 40, which are formed in the radial outer surface 12 of the main body 10, when each magnetic line group 95 is produced and magnetic lines 96 of said magnetic line group 95 move to the radial outer surface 12 of the main body 10, the magnetic lines 96 will be pushed by the magnetic-flux-separating recesses 41 of the magnetic-flux-separating recess assemblies 40. So the outermost magnetic line 96 will be forced to move toward the center of the magnetic line group to which it belongs. As a result, the whole magnetic line group 95 will be more compact.

In other words, the magnetic-flux-separating recesses 41 provide a sufficient reluctance force for the magnetic lines 96 to move toward their center so as to compact the magnetic lines 96 as a whole. Besides, a magnetic flux density for each magnetic line group 95 is also promoted.

Finally, the compacted magnetic line group 95 can prevent the occurrence of the magnetic leakage, therefore lowering the probability for the main body 10 to produce cogging torques during the operation and enhancing the performance of the motor.

The resulting advantages according to the different structures, shapes or numbers of the magnetic-flux-separating recess assemblies 40 are shown as follows.

Regarding the position of the magnetic-flux-separating recess assemblies 40: in the first to the fourth embodiments, the total number of the magnetic-flux-separating recess assemblies 40 is equal to the total number of the magnets 20 (three per unit). The three magnetic-flux-separating recess assemblies 40 and the three magnets 20 are arranged in a staggered manner along the periphery of the main body 10.

On the other hand, in the fifth embodiment, the magnetic-flux-separating recess assemblies 40 are also formed respectively on the radial outer sides of the magnets 20, as shown in FIGS. 7 and 8. Therefore the fifth embodiment outnumbers the first embodiment on the magnetic-flux-separating recess assemblies 40, by which the magnetic line groups 95 may be compacted more intensively, greatly enhancing the operating stability.

Besides, the magnetic-flux-separating recess assemblies 40 which are disposed in the radial outer sides of the magnets 20 can lower the overly intensive magnetic flux on the magnets 20, by which the probability of the occurrence of the cogging torque produced by the magnets 20 and the stator 91 during the operation is also lowered.

Regarding the shape of each magnetic-flux-separating recess 41 in each magnetic-flux-separating recess assembly 40: in the first to the fourth embodiments, each magnetic-flux-separating recess 41 is a circular recess, which is convenient for producing the corresponding mold for forming the circular recess. Meanwhile, the smooth surfaces of each circular recess also prevent damage to the manufacturing mold for the semicircular recess during the manufacturing process of said recesses.

In the fifth embodiment, the shape of the rectangular magnetic-flux-separating recess 41 allows broadening the width of said recess in a fixed depth during the manufacturing process. Therefore the rectangular shape of the magnetic-flux-separating recess 41 can prevent accidentally and overly deepening the recess for the sake of widening the recess. According to the present invention, the critical value for an ideal depth for each magnetic-flux-separating recess 41 is, but not limited to, 6 mm Regarding the number of the magnetic-flux-separating recesses 41 in each magnetic-flux-separating recess assembly 40: in the second to the fourth embodiments, by altering from one circular recess into multiple shallower circular recesses (which are arranged apart from each other), the overall concavity width of one magnetic-flux-separating recess assembly 40 is equal to the sum of the widths of all the shallower recesses. Therefore the manufacturer need not overly deepen one recess in order to broaden the total width for said magnetic-flux-separating recess assembly 40, which may cause some inconvenience during the assembly of the motor. In other words, the second to the fourth embodiments allow the manufacturer to broaden the total width of the magnetic-flux-separating recess assembly 40 to a proper width by combining the widths of all the magnetic-flux-separating recesses 41 in said magnetic-flux-separating recess assembly 40.

On the other hand, a problem arising from having multiple magnetic-flux-separating recesses 41 is the existence of gaps within each two adjacent magnetic-flux-separating recesses 41. The magnetic lines 96 may leak and deviate from these gaps. One single recess, as shown in the first embodiment, which is also a circular recess, can avoid this problem. Meanwhile, the shape of the single recess may be altered from a circle to an arc, and therefore the manufacturer may broaden the width of a magnetic-flux-separating recess 41 to a specific value without overly deepening the depth of said recess.

In summary, the embodiments above show the multiple advantages of a main body having magnetic-flux-separating recesses, which may reduce the cogging torque in the main body while operating and enhance the efficiency of the main body. Therefore the present invention can greatly enhance the efficiency of the main body and the consequent-pole motor in which the main body is mounted.

Experimental data of a consequent-pole motor rotor according to the present invention and a conventional rotor are respectively shown as follows. Conventional consequent-pole motor rotor without magnetic-flux-separating recess:

Rotation Speed Variation

| Item | Overall Efficiency (%) | | | Motor Efficiency (%) | | | Driving Efficiency (%) | | |
|---|---|---|---|---|---|---|---|---|---|
| rpm | 1800 | 2100~3420 | 3600~6000 | 1800 | 2100~3420 | 3600~6000 | 1800 | 2100~3420 | 3600~6000 |
| % | 79.5 | 81.7-85.3 | 85.4-87.6 | 88.2 | 89.0-90.7 | 90.8-91.5 | 90.1 | 91.8-94.2 | 94.1-95.7 |

Load Test: Rotation Speed Variation 8.0 kg-cm

| | | | | | | | Driving | Motor | Overall |
|---|---|---|---|---|---|---|---|---|---|
| | Rotation | Torque | | | Input | Output | Efficiency | Efficiency | Efficiency |
| | Speed | (TQ, | Voltage | Current | Power | Power | (Eff, | (Eff, | (Eff, |
| Item | (rpm) | kg-cm) | (Vav) | (Iav) | (Pi) | (Po) | %) | %) | %) |
| 1 | 1804 | 8.0 | 63 | 1.69 | 186 | 148 | 90.1 | 88.2 | 79.5 |
| 2 | 2104 | 8.0 | 72 | 1.70 | 212 | 173 | 91.8 | 89.0 | 81.7 |
| 3 | 2403 | 8.0 | 81 | 1.71 | 240 | 199 | 92.4 | 89.5 | 82.7 |
| 4 | 2703 | 8.0 | 90 | 1.71 | 265 | 223 | 93.6 | 90.0 | 84.2 |
| 5 | 3004 | 8.1 | 98 | 1.71 | 294 | 249 | 93.3 | 90.7 | 84.6 |
| 6 | 3304 | 8.0 | 107 | 1.71 | 320 | 272 | 93.8 | 90.6 | 85.0 |
| 7 | 3424 | 8.0 | 111 | 1.71 | 330 | 281 | 94.2 | 90.6 | 85.3 |
| 8 | 3604 | 8.0 | 116 | 1.71 | 346 | 295 | 94.1 | 90.8 | 85.4 |
| 9 | 3905 | 8.0 | 125 | 1.72 | 374 | 321 | 94.4 | 90.9 | 85.8 |
| 10 | 4205 | 8.0 | 134 | 1.72 | 402 | 346 | 94.4 | 91.1 | 86.0 |
| 11 | 4504 | 8.0 | 142 | 1.72 | 427 | 371 | 95.0 | 91.4 | 86.8 |
| 12 | 4804 | 8.0 | 151 | 1.72 | 453 | 395 | 95.3 | 91.5 | 87.2 |
| 13 | 5104 | 8.0 | 160 | 1.72 | 481 | 421 | 95.7 | 91.5 | 87.6 |
| 14 | 5406 | 8.0 | 169 | 1.72 | 512 | 444 | 94.8 | 91.4 | 86.6 |
| 15 | 5706 | 8.0 | 178 | 1.73 | 540 | 470 | 95.5 | 91.2 | 87.1 |
| 16 | 6007 | 8.0 | 186 | 1.72 | 572 | 494 | 94.7 | 91.2 | 86.4 |

Torque Variation
Load Test: Torque Variation 3420 rpm

| | | | | | | | Driving | Motor | Overall |
|---|---|---|---|---|---|---|---|---|---|
| | Rotation | Torque | | | Input | Output | Efficiency | Efficiency | Efficiency |
| | Speed | (TQ, | Voltage | Current | Power | Power | (Eff, | (Eff, | (Eff, |
| Item | (rpm) | kg-cm) | (Vav) | (Iav) | (Pi) | (Po) | %) | %) | %) |
| 1 | 3424 | 3.0 | 109 | 0.71 | 139 | 106 | 89.5 | 85.6 | 76.6 |
| 2 | 3424 | 3.5 | 109 | 0.81 | 156 | 123 | 91.0 | 86.9 | 79.0 |
| 3 | 3424 | 4.0 | 110 | 0.90 | 172 | 141 | 92.7 | 88.1 | 81.7 |
| 4 | 3425 | 4.5 | 110 | 1.01 | 193 | 159 | 92.6 | 88.9 | 82.3 |
| 5 | 3425 | 5.0 | 110 | 1.10 | 212 | 176 | 92.9 | 89.4 | 83.1 |
| 6 | 3424 | 5.5 | 110 | 1.20 | 230 | 194 | 93.8 | 89.7 | 84.2 |
| 7 | 3424 | 6.1 | 110 | 1.32 | 253 | 213 | 93.5 | 90.1 | 84.3 |
| 8 | 3424 | 6.5 | 111 | 1.40 | 269 | 229 | 94.2 | 90.3 | 85.0 |
| 9 | 3423 | 7.1 | 111 | 1.52 | 291 | 248 | 94.6 | 90.2 | 85.3 |
| 10 | 3424 | 7.5 | 111 | 1.62 | 311 | 265 | 94.3 | 90.5 | 85.3 |
| 11 | 3424 | 8.0 | 111 | 1.71 | 330 | 281 | 94.2 | 90.5 | 85.2 |
| 12 | 3424 | 8.5 | 111 | 1.82 | 351 | 299 | 94.4 | 90.2 | 85.2 |
| 13 | 3424 | 9.0 | 111 | 1.92 | 371 | 317 | 94.3 | 90.5 | 85.4 |
| 14 | 3424 | 9.5 | 111 | 2.02 | 392 | 334 | 94.1 | 90.5 | 85.1 |
| 15 | 3425 | 10.0 | 112 | 2.11 | 412 | 351 | 94.0 | 90.5 | 85.1 |
| 16 | 3425 | 10.5 | 112 | 2.21 | 433 | 368 | 94.0 | 90.5 | 85.1 |
| 17 | 3424 | 11.0 | 112 | 2.32 | 453 | 386 | 94.5 | 90.3 | 85.3 |
| 18 | 3424 | 11.5 | 113 | 2.43 | 474 | 404 | 94.8 | 90.0 | 85.3 |
| 19 | 3422 | 12.0 | 113 | 2.54 | 495 | 423 | 94.9 | 90.0 | 85.4 |
| 20 | 3423 | 12.5 | 113 | 2.64 | 517 | 440 | 94.8 | 89.9 | 85.2 |
| 21 | 3426 | 13.0 | 114 | 2.73 | 540 | 456 | 94.0 | 89.7 | 84.4 |

The consequent-pole motor rotor with magnetic-flux-separating recesses according to the present invention:

Rotation Speed Variation

| Item | Overall Efficiency (%) | | | Motor Efficiency (%) | | | Driving Efficiency (%) | | |
|---|---|---|---|---|---|---|---|---|---|
| rpm | 1800 | 2100~3420 | 3600~6000 | 1800 | 2100~3420 | 3600~6000 | 1800 | 2100~3420 | 3600~6000 |
| % | 81.0 | 82.1-86.4 | 86.4-88.7 | 88.5 | 89.6-91.7 | 91.8-92.8 | 91.6 | 91.7-94.2 | 94.1-95.5 |

Load Test: Rotation Speed Variation 8.0 kg-cm

| | | | | | | | Driving | Motor | Overall |
|---|---|---|---|---|---|---|---|---|---|
| | Rotation | Torque | | | Input | Output | Efficiency | Efficiency | Efficiency |
| | Speed | (TQ, | Voltage | Current | Power | Power | (Eff, | (Eff, | (Eff, |
| Item | (rpm) | kg-cm) | (Vav) | (Iav) | (Pi) | (Po) | %) | %) | %) |
| 1 | 1801 | 8.1 | 63 | 1.78 | 184 | 149 | 91.6 | 88.5 | 81.0 |
| 2 | 2104 | 8.0 | 72 | 1.77 | 211 | 173 | 91.7 | 89.6 | 82.1 |
| 3 | 2402 | 8.1 | 80 | 1.77 | 236 | 199 | 93.2 | 90.3 | 84.2 |
| 4 | 2702 | 8.0 | 89 | 1.77 | 262 | 223 | 93.7 | 90.9 | 85.2 |
| 5 | 3003 | 8.0 | 98 | 1.77 | 287 | 247 | 93.9 | 91.7 | 86.1 |
| 6 | 3305 | 8.0 | 106 | 1.78 | 318 | 272 | 93.5 | 91.6 | 85.6 |
| 7 | 3423 | 8.0 | 110 | 1.79 | 327 | 282 | 94.2 | 91.7 | 86.4 |
| 8 | 3605 | 8.0 | 115 | 1.78 | 342 | 296 | 94.1 | 91.8 | 86.4 |
| 9 | 3904 | 8.1 | 124 | 1.80 | 371 | 324 | 94.7 | 92.1 | 87.2 |
| 10 | 4203 | 8.0 | 133 | 1.81 | 398 | 347 | 94.8 | 92.0 | 87.2 |
| 11 | 4504 | 8.0 | 141 | 1.81 | 423 | 370 | 95.0 | 92.0 | 87.4 |
| 12 | 4805 | 8.0 | 151 | 1.82 | 451 | 395 | 94.9 | 92.2 | 87.6 |
| 13 | 5105 | 8.0 | 160 | 1.82 | 476 | 417 | 95.1 | 92.2 | 87.7 |
| 14 | 5405 | 8.0 | 169 | 1.84 | 505 | 445 | 95.2 | 92.6 | 88.2 |
| 15 | 5703 | 8.0 | 178 | 1.84 | 546 | 469 | 95.4 | 92.6 | 88.3 |
| 16 | 6005 | 8.0 | 188 | 1.85 | 556 | 493 | 95.5 | 92.8 | 88.7 |

Torque Variation
Load Test: Torque Variation 3420 rpm

| | | | | | Input | Output | Driving | Motor | Overall |
|---|---|---|---|---|---|---|---|---|---|
| | Rotation | | | | Power | Power | Efficiency | Efficiency | Efficiency |
| | Speed | Torque | Voltage | Current | (Pi, | (Po, | (Eff, | (Eff, | (Eff, |
| Item | (rpm) | (kg-cm) | (Vav) | (Iav) | W) | W) | %) | %) | %) |
| 1 | 3425 | 3.1 | 108 | 0.77 | 135 | 108 | 89.6 | 89.2 | 79.9 |
| 2 | 3425 | 3.5 | 108 | 0.86 | 151 | 123 | 90.4 | 90.1 | 81.5 |
| 3 | 3424 | 4.0 | 108 | 0.96 | 169 | 141 | 92.4 | 90.2 | 83.4 |
| 4 | 3424 | 4.5 | 109 | 1.06 | 188 | 160 | 93.0 | 91.2 | 84.8 |
| 5 | 3424 | 5.0 | 109 | 1.16 | 206 | 176 | 93.3 | 91.5 | 85.4 |
| 6 | 3424 | 5.5 | 109 | 1.26 | 226 | 194 | 93.5 | 91.7 | 85.8 |
| 7 | 3424 | 6.0 | 109 | 1.37 | 247 | 212 | 93.5 | 91.9 | 85.9 |
| 8 | 3424 | 6.5 | 109 | 1.46 | 266 | 228 | 93.4 | 91.8 | 85.7 |
| 9 | 3424 | 7.0 | 110 | 1.58 | 288 | 247 | 93.4 | 91.8 | 85.8 |
| 10 | 3423 | 7.5 | 110 | 1.68 | 307 | 264 | 94.0 | 91.4 | 85.9 |
| 11 | 3423 | 8.0 | 110 | 1.79 | 326 | 283 | 94.9 | 91.3 | 86.7 |
| 12 | 3423 | 8.5 | 110 | 1.90 | 347 | 300 | 94.8 | 91.2 | 86.4 |
| 13 | 3424 | 9.0 | 110 | 1.99 | 368 | 318 | 94.3 | 91.5 | 86.3 |
| 14 | 3424 | 9.5 | 111 | 2.09 | 388 | 334 | 94.4 | 91.1 | 86.0 |
| 15 | 3423 | 10.1 | 111 | 2.23 | 414 | 356 | 94.6 | 90.9 | 86.0 |
| 16 | 3425 | 10.5 | 111 | 2.30 | 431 | 370 | 94.1 | 91.1 | 85.8 |
| 17 | 3425 | 11.1 | 112 | 2.43 | 456 | 390 | 94.2 | 90.8 | 85.6 |
| 18 | 3425 | 11.5 | 112 | 2.51 | 472 | 404 | 94.3 | 90.8 | 85.6 |
| 19 | 3424 | 12.0 | 112 | 2.61 | 493 | 421 | 94.3 | 90.6 | 85.4 |
| 20 | 3425 | 12.4 | 113 | 2.70 | 515 | 437 | 93.8 | 90.5 | 84.9 |
| 21 | 3423 | 13.0 | 113 | 2.83 | 535 | 458 | 94.9 | 90.2 | 85.6 |

In the test, for a motor with a conventional rotor at the rotation speed variation of 3423 rpm at an output end of the motor, the driving efficiency, the motor efficiency, and the overall efficiency are 94.2%, 90.6%, and 85.3%, respectively. When the torque variation is 8.0 kg-cm at an output end of the motor, the driving efficiency, the motor efficiency, and the overall efficiency are 94.2%, 90.5%, and 85.2%, respectively.

On the other hand, for a motor with a rotor of the present invention and the rotation speed variation at 3423 rpm at an output end of the motor, the driving efficiency, the motor efficiency, and the overall efficiency are 94.2%, 91.7%, and 86.4%, respectively. When the torque variation is 8.0 kg-cm in an output end of the motor, the driving efficiency, the motor efficiency, and the overall efficiency are 94.9%, 91.3%, and 86.7%, respectively.

Accordingly, by applying the magnetic-flux-separating recess into the rotor in the present invention, the overall performance of the present invention is promoted.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A consequent-pole motor rotor comprising:
a main body being a cylinder and having
two axial end surfaces;
a radial outer surface;
multiple magnet holes axially formed through the main body;
multiple rotor air hole assemblies axially formed through the main body, corresponding in number and position to the magnet holes respectively, wherein each one of the rotor air hole assemblies has
two rotor air holes respectively disposed in two opposite sides of a corresponding one of the magnet holes;
multiple magnetic-flux-separating recess assemblies radially formed in the radial outer surface of the main body, annularly arranged apart from each other, and axially extending to the two axial end surfaces of the main body, wherein each one of the multiple magnetic-flux-separating recess assemblies has
at least one magnetic-flux-separating recess; and
multiple magnets respectively mounted in the magnet holes of the main body.

2. The consequent-pole motor rotor as claimed in claim 1, wherein within each one of the magnetic-flux-separating recess assemblies, each one of the at least one magnetic-flux-separating recess is a circular recess.

3. The consequent-pole motor rotor as claimed in claim 1, wherein within each one of the magnetic-flux-separating recess assemblies, each one of the at least one magnetic-flux-separating recess is a rectangular recess.

4. The consequent-pole motor rotor as claimed in claim 1, wherein a width of each one of the magnetic-flux-separating recess assemblies is from 0.5 mm to 6 mm.

5. The consequent-pole motor rotor as claimed in claim 3, wherein a width of each one of the magnetic-flux-separating recess assemblies is from 0.5 mm to 6 mm.

6. The consequent-pole motor rotor as claimed in claim 1, wherein each one of the magnetic-flux-separating recess assemblies has multiple said magnetic-flux-separating recesses.

7. The consequent-pole motor rotor as claimed in claim 5, wherein each one of the magnetic-flux-separating recess assemblies has multiple said magnetic-flux-separating recesses.

8. The consequent-pole motor rotor as claimed in claim 1, wherein the magnetic-flux-separating recess assemblies are disposed respectively between every two adjacent said magnets along a periphery of the main body.

9. The consequent-pole motor rotor as claimed in claim 7, wherein the magnetic-flux-separating recess assemblies are disposed respectively between every two adjacent said magnets along a periphery of the main body.

10. The consequent-pole motor rotor as claimed in claim 1, wherein a part of the magnetic-flux-separating recess assemblies are respectively disposed between every two adjacent said magnets, and the remaining magnetic-flux-separating recess assemblies are respectively disposed on radial outer sides of the magnets.

11. The consequent-pole motor rotor as claimed in claim 9, wherein a part of the magnetic-flux-separating recess assemblies are respectively disposed between every two adjacent said magnets, and the remaining magnetic-flux-separating recess assemblies are respectively disposed on radial outer sides of the magnets.
